(19) United States
(12) Patent Application Publication
(10) Pub. No.: US 2026/0365199 A1
(43) Pub. Date: Nov. 19, 2026

(54) AUTONOMOUS VEHICLE CONTROL DEVICE AND METHOD

(71) Applicants: Hyundai Motor Company, Seoul (KR); Kia Corporation, Seoul (KR)

(72) Inventor: Woo Joong KIM, Hwaseong-Si (KR)

(21) Appl. No.: 19/392,416

(22) Filed: Nov. 18, 2025

(30) Foreign Application Priority Data
May 15, 2025 (KR) 10-2025-0062951

(51) Int. Cl. B60W 60/00; G01C 21/00

(52) U.S. Cl. CPC B60W 60/001; G01C 21/3833; B60W 2556/10; B60W 2556/20; B60W 2556/40

(57) ABSTRACT

An apparatus of a vehicle may comprise one or more sensors configured to obtain object recognition information about an object outside the vehicle and vehicle traveling information about traveling data of the vehicle, one or more processors coupled to the one or more sensors, and a memory storing one or more programs. When executed by the one or more processors, the one or more programs are configured to cause the apparatus to generate, based on the object recognition information and the vehicle traveling information, first map information on an area in which the vehicle is traveling, determine, based on the vehicle traveling information, a movement amount of the vehicle, obtain and validate new object recognition information, generate second map information, output a signal indicating a traveling route, and control driving of the vehicle.

### CROSS-REFERENCE TO RELATED APPLICATION

This application claims the benefit of priority to Korean Patent Application No. 10-2025-0062951, filed in the Korean Intellectual Property Office on May 15, 2025, the disclosure of which is incorporated herein by reference in its entirety.

### TECHNICAL FIELD

Examples relate to an autonomous vehicle control device and method.

### BACKGROUND

The matters described in this Background section are only for enhancement of understanding of the background of the disclosure, and should not be taken as acknowledgment that they correspond to prior art already known to those skilled in the art.

Autonomous driving technology aims to enable vehicles to recognize their traveling environments and generate routes without driver intervention. To this end, autonomous vehicles collect traveling environment data through various sensors and generate map information based on this data to determine traveling routes.

For autonomous driving technology, a high-definition map (HD map) may be used to generate the traveling route. The HD map may be created in advance using an expensive mobile mapping system (MMS) and include HD information such as lanes, road boundaries, intersections, etc. However, the HD map has a problem in that its current information becomes outdated when road environments change over time (e.g., lane changes or road constructions). For example, when a new lane is added to a road or an existing lane is removed, the HD map may not reflect these changes. In addition, the manufacturing costs of the HD map are high, and it is not practically possible to update all roads in real time.

On the other hand, global positioning satellite (GPS)-based navigation maps provide road shape information, but do not include specific information on each lane line. For example, the navigation map guides the entire route of a road, but it is not practically possible to identify lane changes or track the exact location of a vehicle within a lane. In addition, GPS signals may be often weak or lost in tunnels, urban forests, and similar environments. Due to these limitations, autonomous vehicles have difficulty adapting to the traveling environment that varies in real time.

In addition, a method of generating a local map in real time using sensors is considered. However, the reliability of sensor data may be low due to noise or measurement errors. For example, a camera may incorrectly recognize a lane line due to a change in lighting, and measurement values of a lidar may be incorrect due to rain or fog. In addition, dead reckoning (DR) movement amount calculated through in-vehicle sensors may accumulate errors over time. For example, the drift of a gyroscope or small errors from a speedometer accumulate, making the position estimation of the vehicle inaccurate. Due to these problems, sensor-based local map generation technology may lack accuracy and reliability.

### SUMMARY

Various examples of disclosure are directed to providing an autonomous vehicle control device and method, which generate a real-time local map using sensors previously applied to a vehicle and perform autonomous driving based on the generated local map.

According to the present disclosure, an apparatus of a vehicle may comprise one or more sensors configured to obtain object recognition information about an object outside the vehicle and vehicle traveling information about traveling data of the vehicle, one or more processors coupled to the one or more sensors, and a memory storing one or more programs that, when executed by the one or more processors, are configured to cause the apparatus to generate, based on the object recognition information and the vehicle traveling information, first map information on an area in which the vehicle is traveling, determine, based on the vehicle traveling information, a movement amount of the vehicle, obtain and validate new object recognition information by comparing the new object recognition information with previously obtained object recognition information, generate second map information by updating the first map information based on the validated new object recognition information and the movement amount of the vehicle, output, based on the second map information, a signal indicating a traveling route, and control, based on the signal, driving of the vehicle.

The one or more programs, when executed by the one or more processors, may be configured to cause the apparatus to compare the new object recognition information with a reference value determined based on the previously obtained object recognition information and determine validity of the new object recognition information. The one or more programs, when executed by the one or more processors, may be configured to cause the apparatus to set the reference value using a statistical value of the object recognition information, and the object recognition information has been validated at a previous time point.

The one or more programs, when executed by the one or more processors, may be configured to cause the apparatus to generate correction data based on the new validated object recognition information and the movement amount of the vehicle, and generate the second map information by updating the first map information based on the correction data. The one or more programs, when executed by the one or more processors, may be configured to cause the apparatus to determine an overlap section in which the new object recognition information overlaps the first map information, and the first map information has been adjusted based on the movement amount of the vehicle.

The one or more programs, when executed by the one or more processors, may be configured to cause the apparatus to generate correction data based on a positional difference between the new object recognition information and the first map information within the overlap section. The one or more programs, when executed by the one or more processors, may be configured to cause the apparatus to generate third map information on an area in which the vehicle is traveling based on a portion of the new object recognition information that is outside the overlap section, and merge the third map information with the second map information.

The one or more programs, when executed by the one or more processors, may be configured to cause the apparatus to cluster data included in the second map information based on shape information associated with the data, and interpolate a missing section of the second map information based on an association between clusters corresponding to the clustered data. The one or more programs, when executed by the one or more processors, may be configured to cause the apparatus to determine a reliability value of the first map information or the second map information based on quality, color, and attribute information of the object recognition information, and generate the first map information or the second map information using object recognition information based on the reliability value being greater than or equal to a preset threshold value.

The one or more programs, when executed by the one or more processors, may be configured to cause the apparatus to determine operating states of the one or more sensors based on the object recognition information and the traveling data of the vehicle, and determine, based on the operating states of the one or more sensors, whether to generate the first map information or the second map information.

According to the present disclosure, a method performed by an apparatus of a vehicle may comprise detecting, by one or more sensors of the vehicle, an object outside the vehicle to obtain object recognition information and collecting traveling data of the vehicle to obtain vehicle traveling information, generating, based on the object recognition information and the vehicle traveling information, first map information on an area in which the vehicle is traveling, determining, based on the vehicle traveling information, a movement amount of the vehicle, obtaining and validating new object recognition information by comparing the new object recognition information with previously obtained object recognition information, generating second map information by updating the first map information based on the validated new object recognition information and the movement amount of the vehicle, outputting, based on the second map information, a signal indicating a traveling route, and controlling, based on the signal, driving of the vehicle.

According to the present disclosure, a vehicle may comprise a sensor configured to obtain object recognition information and vehicle traveling information, wherein object recognition information is associated with an object outside the vehicle and wherein the vehicle traveling information is associated with traveling data of the vehicle, a driving control circuit configured to control autonomous driving of the vehicle, and a processor circuit configured to generate, based on the object recognition information and the vehicle traveling information, map information on an area where the vehicle is traveling, determine, based on the vehicle traveling information, a movement amount of the vehicle, validate the object recognition information based on object recognition information validated at a previous time point, update the map information based on the validated object recognition information and the movement amount of the vehicle, output a signal indicating a traveling route based on the updated map information, and control, via the driving control circuit and based on the signal, driving of the vehicle.

The processor circuit may be configured to update the map information by generating correction data based on a positional difference between the object recognition information and the object recognition information validated at the previous time point, and the correction data is determined using a first weighting factor assigned to the object recognition information and a second weighting factor assigned to the object recognition information validated at the previous time point, the second weighting factor being greater than the first weighting factor.

The processor circuit may be configured to interpolate a missing section of the map information by generating a virtual line, wherein the virtual line is determined based on associations between clusters of lane line data or road boundary data derived from the object recognition information. The processor circuit may be configured to assign a reliability value to the object recognition information based on at least one of quality information, color information, or attribute information associated with the object, and generate the map information using the object recognition information based on the reliability value being greater than or equal to a preset threshold.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle communicating with other devices to transmit and receive data;

FIG. 2 shows an example of a module constituting the vehicle according to one example of the present disclosure;

FIG. 3 shows an exemplary operation of an autonomous vehicle control device;

FIGS. 4, 5, 6, 7, 8 show exemplary operations of a processor; and

FIG. 9 shows an example of an autonomous vehicle control method.

FIG. 10 shows an example computing system.

### DETAILED DESCRIPTION

Hereinafter, examples of the present disclosure will be described in detail with reference to the accompanying drawings.

However, the technical spirit of the present disclosure is not limited to some of the described examples, but may be implemented in various different forms, and one or more of the components among the examples may be used by being selectively coupled or substituted without departing from the scope of the technical spirit of the present disclosure.

In addition, terms (including technical and scientific terms) used in examples of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the examples of the present disclosure are for describing the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In addition, terms such as first, second, A, B, (a), (b), and the like may be used to describe components of the examples of the present disclosure.

These terms are only for the purpose of distinguishing one component from another component, and the nature, sequence, order, and the like of the corresponding components are not limited by these terms.

In addition, when a certain component is described as being “connected,” “coupled,” or “joined” to another component, it may include a case in which the certain component is directly connected, coupled, or joined to another component, but also a case in which the certain component is “connected,” “coupled,” or “joined” to another component by still another component present between the certain component and another component.

In addition, when the certain component is described as being formed or disposed “on (above) or below (under)” another component, “on (above)” or “below (under)” may include not only a case in which two components are in direct contact with each other, but also a case in which one or more other components are formed or disposed between the two components. In addition, when described as “on (above) or below (under),” it may include the meaning of not only an upward direction but also a downward direction based on one component.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated or adjusted based on real-time local map updates using validated sensor data. In this case, the updated local map reflects accurate information about lane lines, road boundaries, traffic flow, and environmental conditions, and the vehicle dynamically adapts its driving control features accordingly. For example, when the validated local map indicates a sudden lane narrowing due to construction, the autonomous driving control may automatically lower the driving level to require more driver attentiveness or adjust steering commands to safely remain within the updated boundaries. Similarly, when the updated map identifies a curved road section, braking control, acceleration control, and acceleration change rate control may be modified in advance to ensure smoother handling. In another example, when validated sensor data reveals the presence of a stopped vehicle ahead, the forward collision warning time control and braking time control may be recalibrated to maintain an appropriate safety margin. Based on such real-time updates, the vehicle control may include various operational controls (e.g., autonomous driving control, sensor control, braking control, acceleration control, alarm timing control, etc.) that are continuously optimized to improve safety, efficiency, and reliability under changing driving environments.

One or more auxiliary devices (e.g., engine brake, exhaust brake, hydraulic retarder, electric retarder, regenerative brake, etc.) may also be controlled, for example, based on real-time local map updates using validated sensor data. In this case, the auxiliary devices may be dynamically adjusted according to updated map information that reflects road grade, curvature, obstacles, or traffic conditions with improved accuracy. For example, when validated sensor data and the updated local map indicate that the vehicle is approaching a steep downhill slope, the engine brake or regenerative brake may be pre-activated to reduce reliance on the service brakes and improve stability. Similarly, when the updated local map shows stop-and-go traffic ahead, the regenerative brake may be used more frequently to recover energy while maintaining smooth deceleration. In another example, when validated data reveals slippery road conditions (e.g., rain, snow, or ice patches), the hydraulic or electric retarder may be modulated to provide controlled braking torque and prevent wheel lock-up. By coordinating the auxiliary devices with the validated real-time map information, the system enhances efficiency, safety, and vehicle performance under varying driving conditions.

Minimum risk maneuver (MRM) operation(s) may also be controlled, for example, based on real-time local map updates using validated sensor data. A minimal risk maneuvering operation (e.g., a minimal risk maneuver, a minimum risk maneuver) may be a maneuvering operation of a vehicle to minimize (e.g., reduce) a risk of collision with surrounding vehicles or obstacles by relying on continuously updated and validated map information to reach a lowered (e.g., minimum) risk state. A minimal risk maneuver may be an operation that is activated during autonomous driving of the vehicle when a driver is unable to respond to a request to intervene. For example, when validated sensor data and the updated local map indicate that the vehicle is approaching a construction zone, a narrowing lane, or a stopped vehicle, the driving control apparatus may guide the vehicle toward a safe shoulder, reduce speed, or maintain a biased position within the lane to maximize safety. During the minimal risk maneuver, one or more processors of the vehicle may control a driving operation of the vehicle for a set period of time based on the updated map information (e.g., rerouting toward the nearest safe stop, reducing speed to match detected traffic flow, or avoiding unexpected obstacles) to ensure that the maneuver reflects the real-time driving environment with high reliability.

Biased driving operation(s) may also be controlled, for example, based on real-time local map updates using validated sensor data. A driving control apparatus may perform a biased driving control by referencing continuously updated local map information that reflects lane lines, road boundaries, and nearby vehicles with improved accuracy. To perform biased driving, the driving control apparatus may control the vehicle to drive in a lane by maintaining a lateral distance between the position of the center of the vehicle and the center of the lane, where the lateral distance is dynamically adjusted according to the updated map information. For example, when validated sensor data indicates that a lane line has shifted due to temporary construction or that a large vehicle is detected in an adjacent lane, the driving control apparatus may control the vehicle to stay in the lane but not in the exact center, instead maintaining a biased lateral position for safety. The driving control apparatus may identify or determine a biased target lateral distance using the updated local map to reflect real-world conditions in real time. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle’s stability, safety, and/or performance under varying driving conditions. For example, during a lane change, the driving control system may bias the lateral distance to keep a safer gap from adjacent vehicles, road boundaries, or obstacles detected in the validated local map, considering factors such as the vehicle’s speed, road conditions, and the updated reliability of the sensor data.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on real-time local map updates using validated sensor data. In this case, the operation of each sensor is dynamically adjusted to maintain accuracy and reliability of the updated local map. For example, when the updated local map indicates that a lane line has shifted due to road construction, the camera may be re-oriented or recalibrated to focus on the newly detected boundary, and the LIDAR may increase its scanning density in the overlap region to validate the change. Similarly, when the validated local map detects fog, rain, or inconsistent road markings, the RADAR and traction control sensors may be prioritized over optical sensors to enhance stability. In addition, when the local map update reveals missing sections of lane line data, the IMU and gyroscope sensors may be weighted more heavily to interpolate vehicle position, ensuring that subsequent sensor outputs remain consistent with the real-time environment. Through such coordination, the reliability of both the local map and the sensors themselves is continuously reinforced by validated sensor data.

An autonomous driving level and/or autonomous driving activation/deactivation may also be controlled, for example, based on real-time local map updates using validated sensor data described herein. A driving control apparatus may perform an autonomous driving level control (e.g., adjusting an autonomous driving level, modifying a required user attentiveness, etc.) or cause deactivation of an autonomous driving operation in response to changes in the validated map information. For example, when the updated local map indicates an uncertain or inconsistent recognition result (e.g., due to sensor noise, adverse weather, or missing lane data, etc.), the driving control apparatus may lower the autonomous driving level or increase the required user attentiveness. In such cases, the driver may be required to place his/her hands on the driving wheel more often (e.g., at least once in a threshold time period, such as five seconds, 30 seconds, or 1 minute, etc.) or look ahead more frequently to confirm the driving environment.

Hereinafter, examples will be described in detail with reference to the accompanying drawings, and the same or corresponding components are denoted as the same reference numerals regardless of the reference numerals, and overlapping descriptions thereof will be omitted.

According to the present disclosure, an autonomous vehicle control apparatus and method are provided that allow a vehicle to generate a reliable local map in real time based on data collected from onboard sensors. Autonomous driving systems often depend on pre-constructed high-definition maps, which are costly to update and may not reflect real-world changes such as new lane markings or road construction. Navigation maps based on GPS also lack lane-level accuracy and may suffer from signal loss, while standalone sensor-based approaches may be unreliable due to noise, weather, or accumulated measurement errors. To address these challenges, the present disclosure utilizes vehicle-mounted sensors, including cameras, lidar, radar, and motion sensors, to continuously detect objects and road features surrounding the vehicle and generate a local map that is synchronized to the vehicle’s current position and direction. Data validity is determined using statistical criteria, and only reliable information is incorporated into the map. Errors caused by drift or inconsistent sensor measurements are corrected by comparing new observations with previously validated data, and missing road segments are interpolated by clustering and connecting related map data. The resulting local map provides up-to-date information on lane lines, road boundaries, and driving conditions, enabling the apparatus to determine safe traveling routes and control vehicle behavior in real time. This approach allows the vehicle to respond dynamically to changing environments and maintain stable autonomous driving without relying solely on static map data.

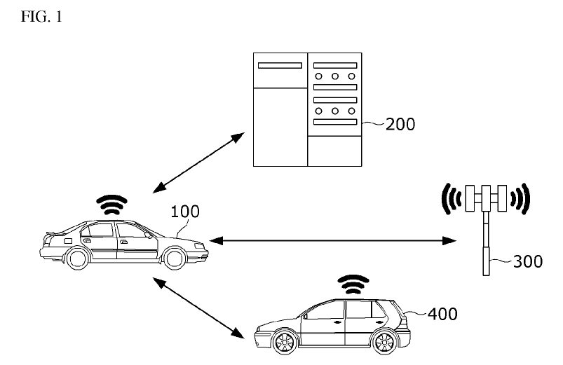

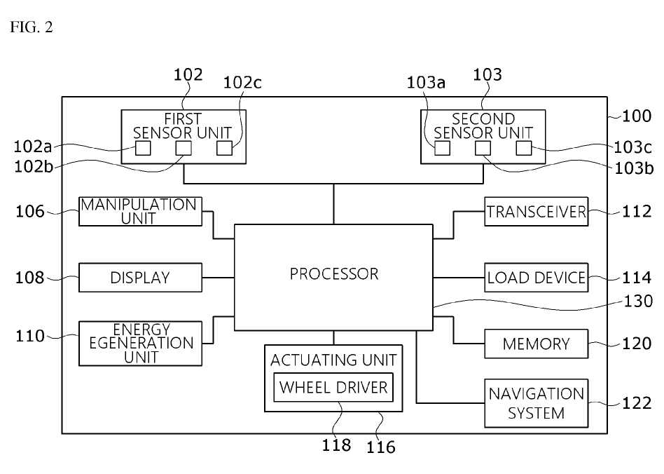

Hereinafter, a vehicle will be described with reference to FIGS. 1 and 2. FIG. 1 shows an example of a vehicle communicating with other devices to transmit and receive data.

Referring to FIG. 1, a vehicle 100 may be driven based on electrical energy or fossil energy. In the case of electric energy, the vehicle 100 may be, for example, a pure battery-based vehicle driven by only a high-voltage battery or may adopt a gas-based fuel cell as an energy source. In addition, a fuel cell may use various types of gases that may generate electrical energy, and the gas may be charged into the vehicle 100, for example, in a liquefied state. Here, the gas may be, for example, hydrogen. However, the present disclosure is not limited thereto, and various gases may be applied (e.g., methane, ammonia, natural gas, or biogas, etc.). In the case of fossil energy, the vehicle 100 may be driven based on fuel such as gasoline, diesel, liquefied gas, etc. and provided with an internal combustion engine that drives an actuating unit 116 by combustion of the fuel. The engine may be included in an energy generation unit 110 from the perspective of providing a driving rotational force of a wheel to a wheel driver 118. As another example, the vehicle 100 may drive the actuating unit 116 selectively using an internal combustion engine based on fossil energy and the energy of an electric battery and may be a hybrid-type vehicle (e.g., parallel hybrid, series hybrid, plug-in hybrid, or mild hybrid, etc.).

The vehicle 100 may be a movable device. The vehicle 100 is a ground vehicle that travels on the ground and may be a typical passenger or commercial vehicle, a purpose built vehicle (PBV), taxi, delivery van, or ride-sharing shuttle, etc. The vehicle 100 may be a four-wheeled vehicle, for example, a passenger car, an SUV, or a small truck, or may be a vehicle with more than four wheels, for example, a bus, a large truck, a container transport vehicle, a heavy equipment vehicle, dump truck, fire truck, crane, or excavator, etc. Here, the ground vehicle may be referred to as not only a vehicle that moves on land but also a vehicle that moves underground. The vehicle 100 may be a robot in a broad sense, such as a means of transportation, and the robot may move using wheels, tracks, or other moving modules. In the present disclosure, a ground mobility device such as a ground vehicle is mainly described, but unless it contradicts the present disclosure, the present example may also be applied to air mobility devices, such as an advanced air mobility (AAM), an aircraft, etc., and water mobility devices, such as a ship, a submarine, etc.

The vehicle 100 may travel under autonomous driving control, and the autonomous driving may be implemented as semi-autonomous driving or full autonomous driving. The fully autonomous driving may be provided as autonomous movement in which a processor 130 of the vehicle 100 has full control authority without user intervention (e.g., lane keeping, automatic overtaking, highway merging, or parking without assistance, etc.), even if a traveling situation is uncertain. The semi-autonomous driving may be provided as autonomous movement that requires driver intervention depending on specific traveling situations (e.g., construction zones, poor weather, unusual traffic signals, or emergency vehicle approach, etc.). The semi-autonomous driving may be implemented by allowing a user to perform manual driving by allowing the processor 130 to deactivate autonomous driving in case of situation and transferring control authority to the user. According to the levels of the autonomous driving defined by the Society of Automotive Engineers (SAE), the semi-autonomous driving may correspond to autonomous driving levels 1 to 4, and the fully autonomous driving may correspond to level 5.

The vehicle 100 may communicate with other devices 200 and 300 or another vehicle 400. The other devices may include, for example, a server 200 for supporting various controls, state management, and traveling of the vehicle 100, an intelligent transportation system (ITS) device 300 for receiving information from an ITS, or various types of user devices (e.g., smartphones, wearable devices, or tablets, etc.). The server 200 may be, for example, an external device operated by a vehicle manufacturer or provided to service autonomous driving and may receive connected data of the vehicle 100 or transmit data required for autonomous driving. To support autonomous driving and various services of the vehicle 100, the server 200 may transmit various types of information and software modules (e.g., navigation updates, hazard alerts, AI-based driving strategies, or infotainment services, etc.) that are used for controlling the vehicle 100 to the vehicle 100 in response to the request and data transmitted from the vehicle 100 and the user device.

The ITS device 300 is, for example, a road side unit (RSU) and may exchange vehicle recognition data, traveling control and state data, surrounding environmental data of a vehicle, map data, etc. with the vehicle 100 through a vehicle-to-infrastructure (V2I) communication to assist a user driving his or her vehicle or support the autonomous driving of the vehicle 100 (e.g., signal phase and timing data, toll information, road hazard broadcasts, or congestion updates, etc.). The vehicle 100 may exchange the data listed above with another vehicle 400 through a vehicle-to-vehicle (V2V) communication to support manual driving or autonomous driving (e.g., cooperative adaptive cruise control, collision warning, or platooning, etc.) .

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as Long Term Evolution (LTE) or 5G, a Wi-Fi communication network, a WAVE communication network, etc. to communicate with the server 200, the ITS device 300, and the other vehicle 400. As another example, DSRC, Bluetooth, Wi-Fi Direct, or satellite communication, etc., used in the vehicle 100 may be used for communication between vehicles. A communication method between the vehicle 100, the server 200, the ITS device 300, another vehicle 400, and the user device is not limited to the above example.

FIG. 2 shows an example of a module constituting the vehicle according to one example of the present disclosure.

In the example, the vehicle 100 may be an autonomous vehicle. The vehicle 100 may include sensor units 102 and 103, a manipulation unit 106, a display 108, a load device 114, and a transceiver 112.

The sensor units 102 and 103 may include various types of detectors for detecting various states and situations that occur in an external environment, internal system, user manipulation, and a space for entering the vehicle 100 (e.g., monitoring tire pressure, detecting rain on the windshield, identifying pedestrian movements, or sensing driver fatigue, etc.).

Specifically, a first sensor unit 102 may include an outer-oriented camera 102a, a lidar sensor 102b, a radar sensor 102c, etc. (e.g., an ultrasonic sensor, infrared sensor, thermal imaging sensor, or night-vision camera, etc.) to recognize dynamic and static objects present outside the vehicle 100. The camera 102a may recognize an external object (e.g., vehicle outline, pedestrian silhouette, or roadside barrier shape, etc.) as an image while used in the vehicle 100 to generate image data and transmit the image data to the processor 130. The lidar sensor 102b may generate point cloud data as data of the recognized external object and transmit the point cloud data to the processor 130 in order to generate three-dimensional spatial information that identifies at least the shape of the external object. The radar sensor 102c may emit radio waves of a specific frequency to a peripheral region of the vehicle 100 to generate radar data through radio waves reflected from the external object in order to identify the presence, a relative distance, a speed, a direction, and the like of the external object (e.g., other cars, cyclists, traffic signs, or animals, etc.). In the present disclosure, the lidar sensor 102b is provided as an example, but in another example, the lidar sensor 102b may not be mounted.

The first sensor unit 102 may generate object recognition information based on sensing data. The object recognition information may include information about whether an object is present, position information of the object, distance information between the vehicle 100 and the object, and relative speed information between the vehicle 100 and the object (e.g., approaching vehicle, crossing pedestrian, or stopped obstacle, etc.). In an example, the external object may be various objects related to the driving of the vehicle 100.

A second sensor unit 103 may include a positioning sensor 103a, a wheel sensor 103b, an attitude sensor 103c (e.g., a GPS receiver, magnetometer, or barometric pressure sensor, etc.), etc. to check a position, speed, driving attitude, and the like of the vehicle. The attitude sensor 103c may include a gyro sensor, an angular velocity sensor, an acceleration sensor, etc. The attitude sensor may be an inertial measurement unit (IMU) sensor and may include a 3-axis accelerometer and a 3-axis gyroscope. The attitude sensor may measure acceleration in a traveling direction x, acceleration in a transverse direction y, acceleration in a height direction z of the vehicle 100 and measure a yaw, a pitch, and a roll as an angular speed of the vehicle (e.g., yaw drift during a turn, pitch changes on a slope, or roll while cornering, etc.).

The second sensor unit 103 may generate vehicle traveling information based on the sensing data. The vehicle traveling information may be information generated based on data detected by various sensors installed in the vehicle. For example, the vehicle traveling information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information (e.g., brake fluid temperature, oil pressure level, cabin air quality, or vibration information, etc.).

In addition, the vehicle traveling information may include route information. The route information may be information generated based on a destination input by a vehicle user through the manipulation unit 106. The route information may be information in which a traveling route from a current position of a host vehicle to a destination is displayed on map information if the destination is set (e.g., highway route, shortest local road, toll-free route, or scenic route, etc.). If the destination is not set, the route information may be information that includes a road on which the host vehicle is currently traveling and a future traveling route including the road. (e.g., predicted next intersection, upcoming exit, or estimated continuation on the current lane, etc.)

The manipulation unit 106 may be formed as a module manipulated by a user for driving. For example, the manipulation unit 106 may be a steering wheel for manual driving, an automatic or manual transmission, an accelerator pedal, a brake pedal, a joystick, a touchpad, or a voice-activated controller (e.g., steering wheel, accelerator pedal, brake pedal, joystick, touchpad, or voice command controller, etc.). The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined location in the vehicle 100 or a soft type interface that may be touched on the display 108 (e.g., physical button, rotary knob, lever, touch panel, or multi-function steering button, etc.). According to specifications of the autonomous driving vehicle, at least one of the steering wheel, the transmission, and the pedals may be omitted. As another example, the manipulation unit 106 may include a module that receives a control request of the user for the load device 114 in addition to driving control (e.g., adjusting air conditioning, opening a sunroof, or operating in-vehicle entertainment, etc.).

The display 108 may serve as a user interface. The display 108 may be controlled by the processor 130 to display an operation state, a control state, route/traffic information, navigation guidance, warning messages, infotainment content, or the remaining energy information of the vehicle 100, a content requested by a driver, etc. In addition, the display 108 may be formed as a touch screen capable of detecting the input of the driver to receive the request of the driver that instructs the processor 130 (e.g., selecting a destination, adjusting climate settings, entering text, or initiating a hands-free call, etc.).

The load device 114 may be mounted on the vehicle 100 and may be a type of non-driving electric device other than a driving power system such as the wheel driver 118 or the like. The load device 114 is an auxiliary device for receiving power from the energy generation unit 110 and may be, for example, various devices installed on an air conditioning system, a lighting system, a seat system, and the vehicle 100 (e.g., cabin heater, LED interior lights, seat position actuator, seat heater/cooler, window regulator motor, or an audio amplifier, etc.). In the present disclosure, a cooling/heating system for cooling or heating at least one of a battery, a fuel cell, an internal combustion engine, an air conditioning system, and a specific portion of the vehicle 100 may be further included (e.g., battery thermal management, hydrogen fuel cell humidifier/heater, engine coolant heater, passenger cabin HVAC, or targeted cooling for electronic control modules, etc.).

The transceiver 112 may support mutual communication with the server 200, the ITS device 300, the nearby vehicle 400, etc. The transceiver 112 may include, for example, a module for processing cellular communication, WAVE communication, DSRC communication, 5G-based V2X communication, Bluetooth, or Wi-Fi Direct, etc. In the present disclosure, the transceiver 112 may transmit data, that is generated or stored while traveling, to the server 200 and receive data and a software module transmitted from the server 200. The transceiver 112 may support communication with an electronic device of a passenger in the vehicle 100 (e.g., a smartphone, tablet, or wearable device, etc.). In the present disclosure, the vehicle 100 may transmit and receive data used in the method according to the present disclosure to and from an external device through the transceiver 112.

For example, the transceiver 112 may receive traffic signal information from a traffic signal controller and provide the traffic signal information to the processor 130. In addition, the transceiver 112 may receive a control signal information from the traffic signal controller and provide the control signal to the processor 130 (e.g., red light timing, green light countdown, or priority vehicle signaling, etc.).

In addition, the vehicle 100 may include the energy generation unit 110 and the actuating unit 116.

The energy generation unit 110 may generate and supply power and electric power that are used in a driving power system and a non-driving power system, such as the actuating unit 116. The non-driving power system may include, for example, the sensor units 102 and 103, the manipulation unit 106, the display 108, the load device 114, the transceiver 112, etc., but is not limited thereto, and may include various components for implementing sensing, interface, communication, and convenience functions other than components directly involved in driving operations (e.g., entertainment systems, climate control units, or auxiliary safety sensors, etc.). When the vehicle 100 is driven based on electric energy, the energy generation unit 110 may be provided as, for example, an electric battery charged from the outside or provided as a combination of an electric battery and a fuel cell that charges the battery. In the case of a combination of the electric battery and the fuel cell, the energy generation unit 110 may include a tank for storing materials used to produce power of the fuel cell, for example, liquefied hydrogen (e.g., cryogenic hydrogen, compressed hydrogen, or methanol reforming fuel, etc.). When the vehicle 100 is driven based on fossil energy, the energy generation unit 110 may be configured as an internal combustion engine. In addition, when the vehicle 100 is a hybrid type, the energy generation unit 110 may be provided as a combination of the internal combustion engine and the electric battery.

The actuating unit 116 may include at least one module that implements a driving operation and perform at least one driving operation of longitudinal control such as acceleration and deceleration and transverse control such as steering according to a user request from the manipulation unit 106. To perform the driving operation according to the manual manipulation of the user or the instruction of the processor 130 according to autonomous driving, the actuating unit 116 may include the wheel driver 118, and mechanical components and electronic modules for implementing the driving operation of the wheel driver 118. When the vehicle 100 is operated based on electrical energy, the vehicle 100 may include an assembly for transmitting the requested driving operation to the wheel driver 118. When the vehicle 100 is operated based on fossil energy, the actuating unit 116 may include a transmission and a gear module for transmitting the power of an internal combustion engine (e.g., automatic gearbox, continuously variable transmission (CVT), or dual-clutch transmission, etc.).

The wheel driver 118 may include a plurality of wheels, a driving force generation module for generating a driving force to impart the driving force to wheels or transmitting the driving force, a brake module for decelerating the driving of the wheels, a steering module for achieving transverse control of the wheels (e.g., electric power steering, hydraulic steering, or steer-by-wire systems, etc.). When the vehicle 100 is driven based on electrical energy, the driving force generation module may be provided as a motor assembly for generating a driving force based on the power output from the electric battery. The brake module of the electric-based vehicle 100 may further have a regenerative brake function.

A navigation system 122 may provide navigation information. The navigation information may include at least one of map information, set destination information, route information according to destination setting, information about various objects on a route, lane line information, and current position information of the vehicle (e.g., toll booth locations, charging stations, rest areas, or accident zones, etc.).

The navigation system 122 may receive information from an external device through the transceiver 112 and update pre-stored information. According to an example, the navigation system 122 may be classified as a subcomponent of the manipulation unit 106.

In addition, the vehicle 100 may include a memory 120 and the processor 130.

The memory 120 may store applications and various types of data for controlling the vehicle 100 and load applications or read or record the data according to the request of the processor 130 (e.g., storing navigation maps, diagnostic logs, multimedia content, or autonomous driving algorithms, etc.).

The processor 130 may perform the overall control of the vehicle 100. The processor 130 may be configured to execute applications and instructions that are stored in the memory 120 (e.g., path planning software, collision avoidance logic, or driver monitoring algorithms, etc.).

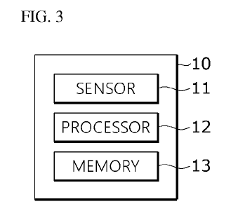

FIG. 3 is a view for describing an autonomous vehicle control device according to an example. Referring to FIG. 3, an autonomous vehicle control device 10 according to the example may include a sensor 11, a processor 12, and a memory 13.

The sensor 11 may detect an object outside the vehicle to generate object recognition information and collect traveling data of the vehicle to generate vehicle traveling information.

The sensor 11 of FIG. 3 includes a first sensor unit and a second sensor unit of FIG. 2, and the processor 12 and the memory 13 of FIG. 3 may have the same configuration as the processor and the memory of FIG. 2.

Specifically, one or more sensors composed of a camera, a lidar, and the like detect external objects, such as lanes, road boundaries, obstacles, traffic signs, traffic lights, pedestrians, vehicles, or obstacles (e.g., lane lines, road boundaries, traffic lights, pedestrians, or nearby vehicles, etc.) around the vehicle to generate object recognition information. The sensors collect traveling data such as a speed, acceleration, directional changes, and the number of wheel rotations of the vehicle from a speedometer, an accelerometer, a gyroscope, a wheel encoder, and the like mounted on the autonomous vehicle to generate vehicle traveling information (e.g., current velocity, angular velocity, wheel slip count, or braking force, etc.). In an example, the object recognition information includes data such as a position, shape, and attributes (e.g., color and quality of the lane line, reflectivity, or brightness, etc.) of the external object detected by the sensor.

The processor 12 performs a process of fusing data generated from the sensor 11, time-synchronizing the data of each sensor, and integrating a coordinate system of each sensor to generate a consistent environment model (e.g., aligning camera images with lidar point clouds, radar detections, or ultrasonic sensor readings, etc.).

The processor 12 generates first map information on an area in which the vehicle is traveling based on the object recognition information and the vehicle traveling information.

In an example, the first map information refers to a real-time local map and includes information such as lane lines, road boundaries, pedestrian crossings, traffic lights, or roadside structures (e.g., lane lines, sidewalks, traffic signals, crosswalks, or curbs, etc.). The real-time local map immediately reflects the environment around the vehicle and provides the latest map data necessary for autonomous driving.

The processor 12 identifies locations of the lane line and the road boundary using the object recognition information collected from the sensor 11. The camera of the sensor 11 detects the color and shape of the lane. For example, the camera recognizes whether the lane lines are white solid lines or yellow dotted lines (e.g., double yellow center lines, dashed white passing lines, or temporary orange construction lines, etc.) and outputs the location of the lane lines as image coordinates.

The lidar of the sensor 11 measures three-dimensional locations of the lane line and the road boundary using a laser. For example, the lidar measures that a centerline between the lane lines is located at x=2 meters and y=0 meters from the vehicle (e.g., left boundary at x=–1.8 m, right boundary at x=+2.0 m, and centerline at x=0.1 m, etc.).

The processor 12 integrates the object recognition information to determine the locations of the lane line and the road boundary. For example, when the camera recognizes the color of the lane line as white and the lidar measures the location of the lane line as x=2 meters and y=0 meters, the processor 12 combines the data to record that the lane line is a white solid line and the location of the lane line is x=2 meters and y=0 meters (e.g., identified as a solid white right-hand boundary at 2 meters from the vehicle, etc.).

The processor 12 determines the position and direction of the vehicle using the vehicle traveling information. The vehicle traveling information includes data collected from the in-vehicle sensor 11.

The speedometer measures the speed of the vehicle. For example, the speedometer measures that the vehicle is traveling at 60 km/h (e.g., 37 mph, etc.).

The accelerometer measures a change in acceleration of the vehicle. For example, the accelerometer measures that the vehicle is accelerating at 1 m/s² (e.g., detecting sudden braking at –2 m/s², or rapid acceleration at +3 m/s², etc.).

The gyroscope measures a rotational angular velocity of the vehicle. For example, the gyroscope measures that the vehicle is rotating at 0.1 rad/s (e.g., slow curve at 0.05 rad/s, sharp turn at 0.5 rad/s, etc.).

A wheel encoder measures the number of wheel rotations. For example, when the circumference of the wheel is 2 meters and the wheel rotates 100 times, a traveling distance is 200 meters (2 × 100) (e.g., 250 rotations = 500 m, etc.).

The processor 12 combines the vehicle traveling information to determine the position and direction of the vehicle. For example, when the vehicle moves from an initial position x=0 m and y=0 meters at a speed of 10 m/s in a direction of 30 degrees (0.5236 rad) for 5 seconds, movement in an x-axis direction is about 43.3 meters, and movement in a y-axis direction is about 25 meters. Accordingly, a current position of the vehicle is x=43.3 meters and y=25 meters (e.g., position updated after lane change or curved path, etc.).

The processor 12 combines the object recognition information and the vehicle traveling information to generate the first map information. The processor 12 converts relative locations of the lane line and the road boundary included in the object recognition information based on the position of the vehicle into a vehicle coordinate system. For example, when the current position of the vehicle is x=43.3 meters and y=25 meters, and the lidar measures the location of the lane line as x=2 meters and y=0 meters from the vehicle, an absolute location of the lane line becomes x=43.3 + 2=45.3 meters and y=25 + 0=25 meters (e.g., right-hand boundary at x=45.3 m, y=25 m, left-hand boundary at x=41.3 m, y=25 m, etc.). The processor 12 converts the locations of the lane line and the road boundary into the vehicle coordinate system in this way and records the locations in the first map information. The first map information includes the location, shape, and color of the lane line, the location of the road boundary, etc.

The processor 12 manages data for each lane line during the process of generating the first map information. The processor 12 divides a buffer to distinguish which part of the traveling lane the information relates to. For example, in the case of a lane line map, data for each lane is managed so that information is not mixed even if a lane change occurs (e.g., left-lane buffer, center-lane buffer, right-lane buffer, etc.). The processor 12 identifies the lane in which the vehicle is currently traveling based on the position and direction of the vehicle. For example, when the vehicle is positioned at x=45.3 meters in a 2-meter-wide lane and the lane line is located between x=44 meters and x=46 meters, the processor 12 determines that the vehicle is traveling within the corresponding lane line. The processor 12 stores lane line information in a lane line-specific buffer. For example, lane line information on a left lane line is stored in a first buffer, and lane line information on a right lane line is stored in a second buffer (e.g., third buffer for adjacent merging lane, etc.).

The processor 12 outputs the first map information as a real-time local map. The real-time local map is generated within a recognition range of the sensor 11. For example, when the sensor 11 has a recognition range of 200 meters forward and 50 meters rearward, the processor 12 generates the first map information including information on lane lines and road boundaries within this range (e.g., 150 m lateral recognition, 80 m rear detection, etc.). The processor 12 outputs the first map information within an available range for generating a traveling route and controlling vehicle behavior. For example, the output range is set to 200 meters in front of the vehicle and 50 meters behind the vehicle, which may be the minimum range required for generating autonomous traveling route and controlling behavior.

The processor 12 determines a movement amount of the vehicle based on the vehicle traveling information. In the example, the movement amount of the vehicle is data for estimating a change in position of the vehicle and is designed to track the movement route of the vehicle even without external environment information (e.g., in a tunnel, parking garage, or GPS-denied urban canyon, etc.).

The processor 12 determines the movement distance and direction of the autonomous vehicle using the vehicle traveling information. To determine the movement distance, the processor 12 integrates speedometer data over time. For example, when it is assumed that the vehicle has moved at a constant speed for a predetermined time, a movement distance is obtained by multiplying the speed by the time. When the speed is 10 m/s and the vehicle moves for 5 seconds, the movement distance is 50 meters (e.g., speed 20 m/s for 3 s = 60 m, etc.).

In addition, the processor 12 uses wheel encoder data. When the circumference of the wheel is 2 meters and the wheel rotates 100 times, the movement distance is 200 meters (e.g., 150 rotations = 300 m, etc.).

In addition, the processor 12 integrates gyroscope data over time to determine a direction. For example, assuming that the vehicle rotates at a constant angular velocity for a predetermined time, the processor 12 determines a directional change by multiplying the angular velocity by the time. When the angular velocity is 0.1 rad/s and the wheel rotates for 3 seconds, the directional change is 0.3 rad (e.g., 0.2 rad/s × 5 s = 1 rad, etc.).

In addition, the processor 12 enhances the accuracy of the directional change additionally using accelerometer data (e.g., correcting gyro drift with linear acceleration values, etc.).

The processor 12 combines the movement distance and the direction data to generate a movement amount of the vehicle. The movement amount of the vehicle is represented as a vector indicating a positional change of the vehicle. For example, when the vehicle moves at a speed of 10 m/s in a direction of 30 degrees (0.5236 rad) for 5 seconds, movement in an x-axis direction is determined by multiplying the speed, the time, and a cosine value of the direction. That is, the movement in the x-axis direction is about 43.3 meters. In addition, the processor 12 determines movement in a y-axis direction by multiplying the speed, the time, and a sine value of the direction. That is, the movement in the y-axis direction is about 25 meters (e.g., combined vector = (43.3, 25), etc.).

The processor 12 accumulates movement based on the initial position and estimates the current position of the vehicle.

The processor 12 uses the movement amount of the vehicle to generate the first map information. Specifically, the processor 12 manages the first map information by reflecting the movement amount of the vehicle and determines whether the existing object recognition information overlaps new object recognition information. In addition, the movement amount of the vehicle is used to manage lane line information through the lane-specific buffer (e.g., adjusting left-lane buffer after lane change, recalculating right-lane buffer after merge, etc.).

The processor 12 compares the collected new object recognition information with the existing object recognition information to determine validity. The processor 12 compares the new object recognition information with a reference value determined based on the existing object recognition information to determine the validity.

The processor 12 sets the reference value using a statistical value of the object recognition information validated at a previous time point.

In an example, the new object recognition information refers to data newly detected by the environment recognition sensor 11 at the current time point, and the existing object recognition information refers to data collected and verified for validity at the previous time point. The validity determination is a process of determining whether the new object recognition information can be reliably used to generate a local map for autonomous driving. To this end, the processor 12 compares the new object recognition information with the reference value determined based on the existing object recognition information (e.g., comparing lane line offsets, verifying road boundary stability, or cross-checking obstacle positions, etc.).

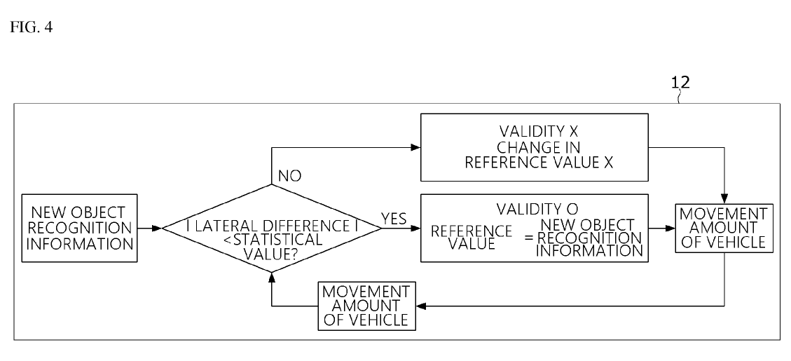

The processor 12 uses a statistical criterion for the validity determination. FIG. 4 shows an exemplary operation of a processor terminal. Referring to FIG. 4 together, the processor 12 sets the reference value using the statistical value of the object recognition information of which validity has been verified at the previous time point. The statistical value is generated based on various log data collected previously. For example, the log data includes data collected by the vehicle through the sensor 11 in various traveling environments (e.g., a straight road, a curved road, an intersection, a tunnel, a highway, or a parking lot, etc.).

The processor 12 analyzes the log data to generate a normal probability density function (PDF). The normal PDF is a PDF that represents the distribution of data and determines the probability of a specific value occurring through a mean and standard deviation of the data. For example, assuming that the data measuring the location of the lane line follows a normal distribution with a mean of 0 meters and a standard deviation of 0.1 meters, the processor 12 extracts statistical values for a filtering criterion using this distribution. The statistical value defines an allowable error range, and for example, a range corresponding to within two standard deviations from the mean (about 95% confidence interval) is set as the criterion for validity determination (e.g., ±0.2 m lateral offset, ±0.05 m vertical displacement, or ±5% angular deviation, etc.).

The processor 12 identifies an overlap section in which the new object recognition information detected by the sensor 11 at the current time point overlaps the reference value. In an example, the overlap section is a section in which the new object recognition information and the existing object recognition information measure the same object (e.g., the same lane line, the same road boundary, or the same obstacle, etc.). For example, when measuring the location of the lane line, the processor 12 compares data for the same section of the same lane line. The processor 12 performs a comparison on the overlap section on the basis of a segment. The segment refers to a unit that divides an object such as a lane line or a road boundary into a predetermined length (e.g., 1 meter, 50 cm, or another fixed unit, etc.).

The processor 12 determines a lateral difference between the new object recognition information and the reference value on the basis of a segment. The lateral difference indicates the extent to which the location of the lane line, for example, a centerline between lane lines, deviates in a left-right direction. For example, when the new object recognition information measures the centerline between the lane lines as x=1.2 m and the reference value is set to x=1.0 meter, the lateral difference becomes 0.2 meters (e.g., 20 cm deviation to the left, etc.). For example, the reference value is compensated in consideration of the movement of the vehicle. Specifically, the processor 12 incorporates the movement amount of the vehicle into the reference value (e.g., shifting the reference lane position by 1 meter forward after straight driving, or rotating it by 0.3 rad after turning, etc.).

As described above, the movement amount of the vehicle is a value determined by calculating the movement distance and direction of the vehicle based on data collected from the in-vehicle sensor 11 (e.g., a speedometer, a gyroscope, an accelerometer, a wheel encoder, or a GPS receiver, etc.). For example, when the vehicle moves straight by 1 meter during a reference time, the processor 12 compensates for the reference value by shifting its position by 1 meter (e.g., 5 meters forward movement shifts the reference value by 5 meters, or a 0.2 rad rotation updates the reference angle by 0.2 rad, etc.). This allows the new object recognition information and the reference value to be compared in the same coordinate system.

The processor 12 compares the determined lateral difference with the statistical value to determine validity. The statistical value is a range set based on the above normal PDF. For example, when the statistical value is set to within 2 standard deviations (0.2 meters) from the mean and the lateral difference is 0.2 meters or less, the processor 12 determines that the new object recognition information is valid (e.g., a lateral shift of 0.1 m, a boundary offset of 0.05 m, or a centerline deviation of 0.15 m is accepted as valid, etc.). Alternatively, when the lateral difference exceeds 0.2 meters, the processor 12 determines that the new object recognition information is invalid. This is based on the principle that, when the same object is measured, an almost similar shape needs to be recognized during the reference time, for example, since a positional change of the lane line of 0.2 meters or more within 0.1 seconds is physically impossible or considered as noise of the sensor 11, the processor 12 determines that such data is invalid (e.g., sudden lane jump, ghost object detection, or sensor glitch, etc.).

The processor 12 excludes invalid new object recognition information from being used as the reference value. On the other hand, the processor 12 uses the new object recognition information determined to be valid as the reference value when determining the validity of the next object recognition information. Accordingly, the processor 12 continuously maintains highly reliable data as the reference value. For example, lane line location data determined to be valid at the current validity determination time point is set as a reference value at the next validity determination time point and compared with the new object recognition information (e.g., a left-lane boundary confirmed as valid is stored and reused until the next update, etc.).

The processor 12 updates the first map information based on the new object recognition information validated and the movement amount to generate second map information. The processor 12 generates correction data based on the new object recognition information validated and the movement amount of the vehicle and updates the first map information based on the correction data to generate the second map information.

For example, the processor 12 determines an overlap section in which the new object recognition information overlaps the first map information reflecting the movement amount of the vehicle and generates the correction data based on an error between the new object recognition information and the first map information in the overlap section (e.g., error of ±0.1 m lateral shift, ±0.05 rad orientation, or ±0.5 m longitudinal displacement, etc.).

In addition, the processor 12 generates third map information on an area in which the vehicle is traveling based on the new object recognition information that is not included in the overlap section and merges the third map information with the second map information (e.g., adding new road signs, merging new lane markings, or inserting newly detected roadside curbs, etc.).

The processor 12 determines an overlap section in which the new object recognition information overlaps the first map information reflecting the movement amount of the vehicle to generate correction data. The first map information is a real-time local map generated at the previous time point and includes information such as lane lines, road boundaries, traffic signs, or obstacles (e.g., lane lines, curbs, speed limit signs, or stop lines, etc.). The overlap section is a section in which the new object recognition information and the first map information measure the same object. For example, when the location of the lane line is measured, the processor 12 compares data for the same section of the same lane line (e.g., comparing a 10-meter segment of the left boundary line across consecutive updates, etc.).

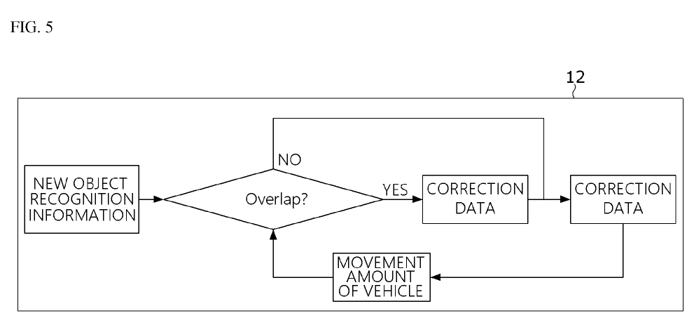

FIG. 5 shows an exemplary operation of a processor. Referring to FIG. 5 together, the processor 12 identifies the overlap section by reflecting the movement amount of the vehicle into the first map information. Specifically, the processor 12 moves the coordinates of the first map information using the movement amount of the vehicle. For example, when the vehicle moves straight by 1 meter, the lane line is compensated by moving the location of the lane line included in the first map information by 1 meter (e.g., shifting the left boundary line forward, extending the centerline by 1 meter, or moving a stop line marker, etc.). This allows the new object recognition information and the first map information to be compared in the same coordinate system.

The processor 12 generates correction data based on the error between the new object recognition information and the first map information in the overlap section. In an ideal situation, the first map information reflecting the movement amount of the vehicle and the new object recognition information need to be the same in the overlap section. However, a difference occurs between the two data due to the accumulated error of the movement amount of the vehicle and the measurement error of the sensor 11. The accumulated error in the movement amount of the vehicle results from the accumulation of minute errors (e.g., drift of the gyroscope, accelerometer bias, or wheel slip, etc.) of the in-vehicle sensor 11 over time, and the measurement error of the object recognition information is caused by noise of the sensor 11 or environmental factors (e.g., a change in lighting or a road surface condition, falling leaves, or shadows from surrounding vehicles, etc.).

The processor 12 determines a positional difference between the new object recognition information and the first map information in the overlap section. For example, when the new object recognition information measures the centerline between the lane lines as x=1.2 meters and the first map information reflecting the movement amount of the vehicle is set to x=1.0 meter, the positional difference becomes 0.2 meters (e.g., deviation of 20 cm to the right, etc.).

The processor 12 generates a weight based on the positional difference and generates correction data. The weight is set in consideration of the reliability of the first map information and the new object recognition information. Since the first map information is data generated by accumulating measurement values at the previous time point, it is determined that reliability is higher. Accordingly, the processor 12 gives a greater weight to the first map information. For example, a weight of 0.7 is given to the first map information and a weight of 0.3 is given to the new object recognition information (e.g., 70% reliance on stored lane data vs. 30% reliance on newly detected lane line, etc.). The processor 12 determines the correction data using the weight. When the positional difference is 0.2 meters, a weight of the first map information is 0.7, and a weight of the new object recognition information is 0.3, the correction data becomes 0.06 meters. This is a method of determining the correction data by reflecting 30% of the influence of the new object recognition information. Various methods may be applied to determine the weight, and for example, the weight may be dynamically adjusted according to the quality information of the sensor 11 (e.g., signal-to-noise ratio, visibility, or sensor calibration state, etc.).

The processor 12 updates the first map information based on the correction data to generate the second map information. The second map information is a real-time local map reflecting the correction data and includes information such as lane lines, road boundaries, traffic signs, and road markers (e.g., pedestrian crosswalk lines, stop bars, or arrow markings, etc.). The processor 12 applies the correction data to the first map information to adjust the location. For example, when the correction data is 0.06 meters, the first map information is updated by moving the location of the lane line of the first map information by 0.06 meters (e.g., shifting a left boundary line, adjusting a right lane marker, or correcting a centerline position, etc.). The processor 12 manages the first map information using the movement amount of the vehicle. Specifically, the processor 12 continuously updates the coordinates of the first map information by reflecting the movement amount of the vehicle (e.g., adding forward displacement, compensating for angular rotation, or correcting lateral drift, etc.). Additional correction data is generated using the first map information and the new object recognition information that belong to a field of view (FOV) of the environment recognition sensor 11. For example, when the FOV of the environment recognition sensor 11 extends 200 meters forward, the first map information and the new object recognition information within this range are compared to generate correction data (e.g., comparing overlapping segments of lane boundaries between 50–150 meters forward, etc.).

The processor 12 manages data through the lane-specific buffers during the process of generating the second map information. The processor 12 divides a buffer to distinguish which part of the traveling lane the information relates to. For example, in the case of a lane line map, data for each lane is managed so that information is not mixed even when a lane change occurs. The processor 12 is designed with logic capable of distinguishing individual lanes and may respond to a lane change. For example, when a vehicle changes from a left lane to a right lane, the processor 12 moves data of the corresponding lane to a separate buffer and manages the data (e.g., shifting lane-specific map data from buffer 1 to buffer 2, etc.).

In addition, the processor 12 merges similar data to increase resource management efficiency. To this end, a Douglas-Peucker algorithm is applied. The Douglas-Peucker algorithm is an algorithm that simplifies a line composed of multiple points and reduces the data size by merging similar points. For example, the processor 12 merges points that may be linearly approximated among consecutive points of the lane line into one line segment. When the lane line consists of 10 points and 8 of them may be linearly approximated, the processor 12 merges the 8 points into one line segment to reduce the data size. Accordingly, the processor 12 generates continuous second map information while saving resources (e.g., less memory usage, faster map rendering, or lower CPU load, etc.).

The processor 12 generates third map information on the area in which the vehicle is traveling based on the new object recognition information that is not included in the overlap section. When there is no overlap section, the processor 12 may not generate correction data, and thus generates new map information based on the new object recognition information. For example, when a vehicle enters a new road section and there is no section in which the new object recognition information overlaps the first map information, the processor 12 generates the third map information based on the new object recognition information (e.g., new lane boundaries, roadside barriers, or traffic signs on a previously unmapped road section, etc.). The third map information is later used as the first map information.

When the overlap section is present, the processor 12 generates correction data for the overlap section and updates the first map information to generate the second map information, and for a section in which there is no overlap section, the processor 12 generates the third map information using the new object recognition information and merges the third map information into the second map information (e.g., overlap section = correcting lane line deviations, non-overlap section = adding new road boundaries, traffic signs, or crosswalk markings, etc.). For example, when the new object recognition information includes lane line information from 50 meters to 150 meters in the forward direction and the first map information includes lane line information from 0 meters to 100 meters in the forward direction, a section from 50 meters to 100 meters in the forward direction is processed as the overlap section, and a section from 100 meters to 150 meters in the forward direction is processed as a section without the overlap section (e.g., overlap section = 50–100 m, new section = 100–150 m, etc.).

The processor 12 clusters the data of the second map information based on shape information and interpolates a missing section of the object recognition information in the second map information based on associations between the clusters (e.g., grouping lane segments by curvature, slope, or alignment, etc.).

The processor 12 generates a virtual line to interpolate the missing section of the object recognition information in the second map information. The missing object recognition information is caused by various causes. For example, when a vehicle turns at an intersection, the sensor 11 may not measure the lane line, or data is not collected in a section located outside the FOV of the sensor 11 (e.g., blind spots during a sharp curve, occlusion by a truck, or faded road markings, etc.). In such a situation, the virtual line needs to be generated to secure the continuity of the second map information. In an example, the virtual line is a line that interpolates map data in a section in which the sensor 11 does not measure and estimates the shape of the lane line or the road boundary.

In an example, the processor 12 performs the operation of generating a virtual line in three steps including clustering, association analysis, and interpolation. The clustering is a technique used in data mining and pattern recognition and groups similar data, thereby increasing analysis efficiency. In addition, the association analysis is a process for maintaining the continuity of the map data and complements the incompleteness of the sensor 11 data in autonomous driving (e.g., associating left-lane fragments, extrapolating road edges, or reconstructing partially missing crosswalk lines, etc.).

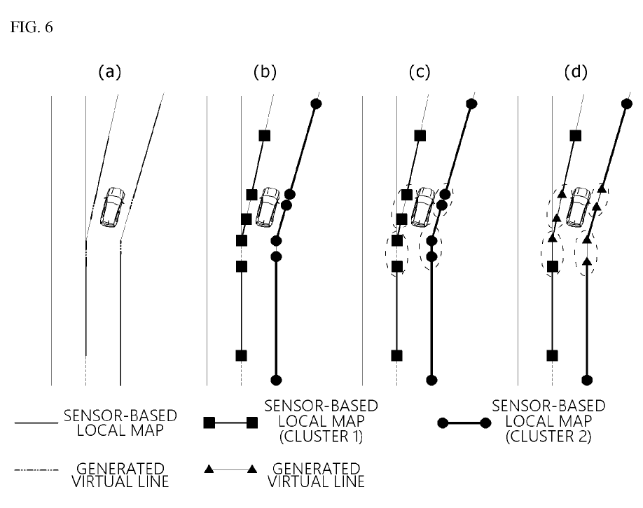

FIG. 6 shows an exemplary operation of a processor. Referring to FIGS. 6A and 6B together, the processor 12 clusters the data of the second map information based on the shape information. The clustering is a process of grouping data with similar characteristics and classifies points of lane lines or road boundaries included in the second map information according to shape similarity (e.g., straight segments, curved segments, sharp corners, or branching boundaries, etc.). For example, when lane line location data is represented as points, the processor 12 analyzes the distance and direction between the points and groups points that are likely to be connected by a straight line or curve into a single cluster. The clustering may use a clustering technique such as a K-means algorithm. The K-means algorithm repeats a process of dividing data into K clusters, assigning each point to the center of the closest cluster, and repeating the process of updating the center of the cluster as the mean of the points. For example, the lane line data consists of 100 points, and in order to divide the lane line data into 3 clusters, the processor 12 sets the initial 3 center points, assigns the points to the closest center points, and updates the center points to form a final cluster (e.g., grouping left-lane, right-lane, and centerline clusters, etc.).

Referring to FIG. 6C, the processor 12 analyzes the associations between clusters in the clustered data. The associations refer to a process of evaluating the possibility that clusters are connected and is performed based on the shape information. The processor 12 analyzes the shape characteristics of each cluster. For example, when one cluster represents a straight lane line and the other cluster represents a curved lane line, the processor 12 compares a distance, direction, curvature, etc. between endpoints of the two clusters (e.g., endpoint-to-endpoint gap, angular offset, or radius of curvature difference, etc.). Specifically, when a last point of a first cluster is located at x=50 meters and y=0 meters and the direction is 0 degrees (going straight), and when a first point of a second cluster is located at x=55 meters and y=1 meter and the direction is 5 degrees, the processor 12 determines that the possibility of connection is high because the distance between the two points is about 5.1 meters and a direction difference is 5 degrees. On the other hand, when the direction difference is large, such as 90 degrees, it is determined that the possibility of connection is low.

Referring to FIG. 6D together, the processor 12 generates a virtual line based on associations. The generation of the virtual line is a process of interpolating the missing section between clusters with a high possibility of connection. The processor 12 generates a line connecting endpoints of two clusters. For example, when the last point of the first cluster is x=50 meters and y=0 meters and the first point of the second cluster is x=55 meters and y=1 meter, the processor 12 generates a straight line connecting the two points. The equation of the straight line is obtained by calculating its slope and intercept. The processor 12 interpolates the missing section by generating points between x=50 meters and x=55 meters based on the above equation e.g., generating 10 evenly spaced interpolation points along the straight line, etc.).

In the case of a curved section, the processor 12 may use an interpolation technique such as a spline curve in consideration of the curvature of the cluster. The spline curve is a curve that smoothly connects multiple points and maintains the continuity of the curvature.

In addition, the processor 12 considers a specific situation during the process of generating a virtual line. For example, in a turning situation, even when some measurements are missing, associations may be found based on a shape. When a vehicle is traveling on a curved road and the first cluster represents the beginning of the curve and the second cluster represents the end of the curve, the processor 12 analyzes a curvature and a direction to interpolate a middle section into a curve (e.g., reconstructing a U-turn arc or a highway exit ramp curve, etc.).

The processor 12 incorporates the generated virtual line into the second map information to interpolate the missing section. The virtual line secures the continuity of the second map information and maintains the shape of the lane line or the road boundary. For example, when the virtual line is generated in a 5-meter section in which the lane data is missing, the processor 12 restores the continuity of the lane line by adding the virtual line to the second map information (e.g., filling gaps caused by occlusion, faded paint, or poor sensor visibility, etc.). Accordingly, the second map information provides consistent map data even in sections in which the sensor 11 fails to perform measurements.

The processor 12 determines a reliability value of the map information based on the quality, color, and attribute information of the object recognition information and generates map information using the object recognition information with a reliability value at or above a preset threshold value.

In an example, the reliability value is an indicator indicating how reliably the object recognition information may be used to generate map information for autonomous driving. The processor 12 generates map information using object recognition information having a reliability value at or above the preset threshold value. For example, when the threshold value is set to 1, object recognition information of which reliability value is 1 or more is used to generate map information, and when the threshold value is less than 1, the object recognition information is excluded (e.g., low-confidence detections of lane color or shape are filtered out, etc.). Accordingly, the processor 12 incorporates highly reliable data into the map information.

In order to determine the reliability value, the processor 12 analyzes how the quality, color, and attribute information are measured continuously while the sensor 11 measures the same location multiple times. Specifically, the processor 12 first evaluates quality information, and then determines a final reliability value by checking the continuity of the color and attribute information (e.g., consistent detection of white solid lines vs. inconsistent detection of dashed yellow lines, etc.).

For example, the quality information represents the accuracy of the data measured by the sensor 11 and has a value from 0 to 3. The processor 12 determines that the measured data is accurate when the quality value is 3, and reliability is low when the quality value is 0 (e.g., high-quality detection under clear daylight vs. low-quality detection in heavy rain, etc.).

In addition, the color information represents a color (e.g., white, yellow, or blue temporary construction markings, etc.) of a lane line, and the attribute information represents the type (e.g., a solid line, a dotted line, or a double line, etc.) of the lane line.

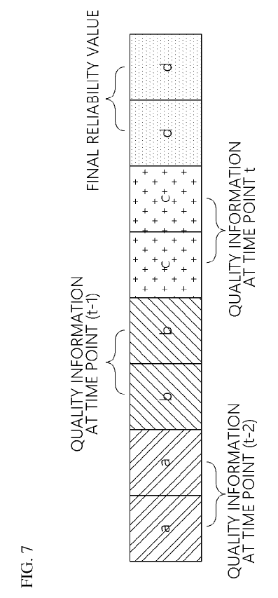

FIG. 7 shows an exemplary operation of a processor. Referring to FIG. 7 together, the processor 12 determines a reliability value based on the quality information. The processor 12 accumulates the quality information of the front lane line in the buffer and assigns a reliability value. Here, the buffer consists of 8-bit data (aa bb cc dd), and aa stores the oldest quality information, bb stores the next oldest quality information, and cc stores the latest quality information (e.g., aa=oldest sample, bb=intermediate sample, cc=current sample, dd=calculated reliability value, etc.). Since the quality information has values from 0 to 3, each quality information is represented as 2 bits. For example, when aa, bb, and cc are 3, 2, and 3, respectively, the processor 12 determines that the average of these values is about 2.67. The processor 12 rounds down the average value and assigns a final reliability value to dd. Accordingly, the above average of 2.67 is rounded down to 2, and dd is set to 2. The last lower 2 bits (dd) represent the final reliability value (e.g., aa=3, bb=2, cc=3 → avg=2.67 → dd=2, etc.).

The processor 12 updates the buffer with the latest quality information that enters the FOV of the sensor 11 while traveling even when the same object is not recognized continuously. For example, when newly measured quality information is 1, aa and bb move to bb and cc, respectively, and cc is updated with 1 (e.g., [aa=3, bb=2, cc=3] → [aa=2, bb=3, cc=1], etc.).

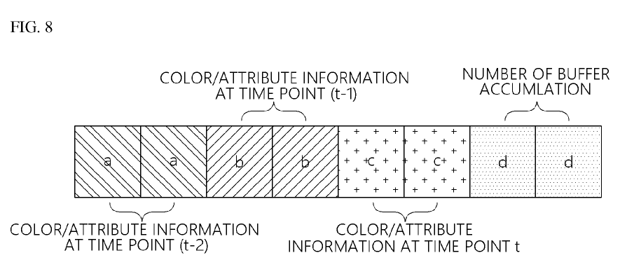

FIG. 8 shows an exemplary operation of a processor. Referring to FIG. 8 together, the processor 12 adjusts the reliability value using color information. The color information represents the color of the lane line, and a difference occurs between a measured lane line value of the driving lane and a measured lane line value of the next lane. For example, even when it is accurately measured that the color of the lane line of the driving lane is white, it is measured that the lane line of the next lane may be unknown, faded, or inconsistent (e.g., white in one frame, yellow in another, or unrecognized due to poor lighting, etc.) even though the color thereof is white. The processor 12 incorporates the inaccuracy of a color flag into the reliability value (e.g., lowering reliability when colors are inconsistent across consecutive measurements, or maintaining reliability when color readings are stable, etc.). The processor 12 checks the continuity of the color information. For example, when the same color of the lane line is measured three times consecutively at the same location, the processor 12 maintains the current reliability value. Even when the lane line color is white but the sensor 11 measures that the lane line color is a different color (e.g., yellow or blue construction markings, etc.), the processor 12 maintains the reliability value when the same color (yellow) of the lane line is measured three times consecutively. This reflects the consistency of the sensor 11 in the reliability determination.

In addition, the processor 12 lowers the reliability value when the color information is not continuous. The processor 12 analyzes the color information accumulated three times in the buffer. For example, when the color information is accumulated three times but only two are the same color (e.g., white, white, or yellow, etc.), the processor 12 decreases the reliability value by 1. When the color information has been accumulated three times but all are different colors (e.g., white, yellow, or unknown, etc.), the processor 12 decreases the reliability value by 2. When the color information has been accumulated only twice in the buffer but both are the same color (e.g., white, white, etc.), the processor 12 decreases the reliability value by 1. In other cases (e.g., when the color information is accumulated only once), the processor 12 decreases the reliability value by 2. The processor 12 sets the minimum reliability value to 1 when a sensor 11-based local map is present. For example, even when the reliability value decreases from 2 to 0, the reliability value is maintained as the minimum value of 1 (e.g., preventing a total drop to 0, which would block map generation, etc.).

In addition, the processor 12 additionally adjusts the reliability value using attribute information. The attribute information represents the type (e.g., a solid line, a dotted line, double line, or dashed centerline, etc.) of the lane line and evaluates continuity similarly to the color information. The processor 12 determines that the reliability is high when the attribute information matches continuously at the same location. For example, the processor 12 maintains the reliability value when it is consecutively measured three times that the type of the lane line is a solid line, and decreases the reliability value by 1 when only two of the three times are solid lines and one is a dotted line (e.g., solid–solid–dotted sequence, etc.). The continuity determination of the attribute information is performed in the same manner as the color information (e.g., consistent detection of solid lines maintains reliability, while mixed solid/dotted detections reduce reliability, etc.).

The processor 12 sets the variable size of the reliability value to 8 bits, 16 bits, 32 bits, , or other selectable sizes (e.g., 64 bits when extended precision is required, etc.) for resource efficiency. In an example, the reliability value will be described based on 8 bits, but a larger variable size may be used as needed (e.g., 16 bits for higher-resolution scoring or 32 bits for multi-sensor fusion, etc.). When the reliability value is set to 8 bits, the reliability value has a range from 0 to 3, thereby minimizing the usage of the memory 13. For example, in 8-bit data, quality information is allocated to 6 bits (aa, bb, cc) and the reliability value is allocated to 2 bits dd, and thus a total of 256 states may be represented (e.g., 2⁸=256 possible states, etc.).

The processor 12 generates a traveling route based on the second map information and controls the behavior of the vehicle. The processor 12 analyzes the lane line information included in the second map information to generate a traveling route. The processor 12 determines a route that the vehicle needs to travel based on the location and shape of the lane line (e.g., straight, curved, or branching, etc.). For example, when the lane line is a straight line extending 100 meters forward, the processor 12 sets the route so that the vehicle travels straight along the center line of the lane lines. When the lane line is formed as a curve, the processor 12 analyzes a curvature of the curve and generates a route so that the vehicle travels along the curve. The curvature is determined as a change in direction between points of the lane line (e.g., gentle curve radius vs. sharp corner, etc.). The processor 12 sets a steering angle of the vehicle based on this curvature.

The processor 12 controls the behavior of the vehicle based on the generated traveling route. The processor 12 adjusts the speed, steering angle, and acceleration of the vehicle according to the traveling route. For example, on a straight route, the processor 12 controls the vehicle to maintain a constant speed (e.g., 60 km/h, 70 km/h, etc.), and on a curved route, the processor 12 reduces the speed (e.g., 40 km/h on a mild curve, 30 km/h on a sharp curve, etc.) and adjusts the steering angle according to the curvature. The processor 12 monitors the vehicle traveling information in real time and determines whether the vehicle follows the traveling route. For example, when the vehicle deviates from the traveling route by 0.5 meters, the processor 12 adjusts the steering angle to return to the route (e.g., applying a 5° corrective steering input, etc.). Accordingly, the processor 12 controls the vehicle to stably follow the traveling route based on the second map information.

The processor 12 determines the operating state of the sensor 11 based on the object recognition information and the traveling data of the vehicle and determines whether to generate map information according to the operating state of the sensor 11. For example, the map information may include the first map information, the second map information, or updated hybrid map information (e.g., fused with GPS or HD map data, etc.).

The processor 12 activates the generation of map information when the operating state of the sensor 11 is normal. Specifically, when the sensor 11 operates normally to generate object recognition information such as lane lines, road boundaries, traffic signs, or roadside obstacles (e.g., lane markings, curbs, crosswalks, speed limit signs, or guardrails, etc.) and the in-vehicle sensor 11 operates normally to collect vehicle traveling information such as a speed, an acceleration, a steering angle, or a wheel rotation count (e.g., from a speedometer, accelerometer, gyroscope, or wheel encoder, etc.), the processor 12 activates the generation of the map information.

The processor 12 deactivates the generation of the map information when the operating state of the sensor 11 is abnormal. Specifically, when the sensor 11 does not operate normally and may not generate the object recognition information (e.g., camera failure, lidar signal loss, or radar interference, etc.), or when the in-vehicle sensor 11 does not operate normally and may not collect the vehicle traveling information (e.g., speedometer malfunction, gyroscope drift, or accelerometer fault, etc.), the processor 12 deactivates the generation of the map information. For example, when the camera is broken and may not detect a lane line, or the speedometer is broken and may not collect speed data, the processor 12 stops generating the map information (e.g., during sensor hardware failure, extreme weather interference, or signal blackout in tunnels, etc.). This is for preventing the generation of the map information having low reliability data.

When the generation of the map information is deactivated, the processor 12 generates a traveling route using a pre-stored HD map or navigation-based map (e.g., stored map database, cloud-synced HD map, or GPS-based navigation map, etc.).

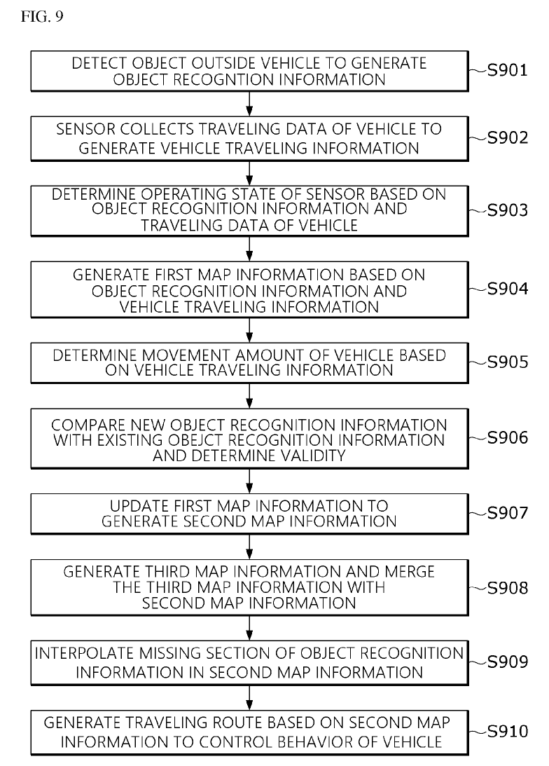

FIG. 9 shows an example of an autonomous vehicle control method according to the example.

Referring to FIG. 9, first, the sensor detects an object outside a vehicle and generates object recognition information (S901).

At the same time, the sensor collects vehicle traveling data and generates vehicle traveling information (S902).

Next, the processor determines the operating state of the sensor based on the object recognition information and the vehicle traveling data. The processor determines whether the environmental recognition sensor and the in-vehicle sensor are operating normally (e.g., camera and lidar for external objects, speedometer and gyroscope for vehicle motion, or accelerometer and wheel encoder for dynamic stability, etc.). For example, when the camera accurately recognizes a lane line, a lidar measures a location of the lane line, and a speedometer accurately measures a speed, the processor determines that the sensor is operating normally. Conversely, when the camera is broken and may not detect the lane line (e.g., blurred lens, hardware damage, or heavy rain interference, etc.) or the speedometer may not output data (e.g., disconnection, sensor fault, or abnormal readings, etc.), the processor determines that the sensor is operating abnormally (S903).

When the operating state of the sensor is normal, the processor generates first map information on an area in which the vehicle is traveling based on the object recognition information and the vehicle traveling information. The first map information refers to a real-time local map and includes information such as lane lines, road boundaries, traffic signs, or road markers (e.g., crosswalks, stop lines, or guardrails, etc.).

Subsequently, the processor determines a movement amount of the vehicle based on the vehicle traveling information. The movement amount of the vehicle is dead reckoning (DR) movement amount and determines a movement distance and direction of the vehicle based on data collected from the in-vehicle sensor (S905) (e.g., speedometer, gyroscope, accelerometer, or wheel encoder, etc.).

Next, the processor compares new object recognition information being collected with existing object recognition information and determines validity. The processor compares the new object recognition information with a reference value determined based on the existing object recognition information. The processor sets the reference value using a statistical value of the object recognition information validated at a previous time point. A normal PDF is generated based on previously collected log data, and the statistical value is extracted from the normal PDF. For example, the processor compares an overlap section between the new object recognition information and the reference value on the basis of a segment to determine a lateral difference. When the lateral difference is within the statistical value, the processor determines that the new object recognition information is valid (S906) (e.g., lane line deviation within ±0.2 m, curvature change within a tolerance range, etc.).

Thereafter, the processor updates the first map information based on the new object recognition information validated and the movement amount of the vehicle to generate second map information. The processor determines the overlap section in which the new object recognition information overlaps the first map information reflecting the movement amount of the vehicle. The overlap section is a section in which the new object recognition information and the first map information measure the same object (e.g., the same lane line segment, road boundary, or traffic sign, etc.). The processor generates correction data based on an error between the new object recognition information and the first map information in the overlap section (S907) (e.g., lateral error of 0.1 m, orientation error of 0.05 rad, or longitudinal shift of 0.3 m, etc.).

The processor generates third map information based on the new object recognition data that is not included in the overlap section and merges the third map information with the second map information. For example, lane line data of a new road section (e.g., extension beyond 100 m forward, new side road boundaries, or construction detours, etc.) is generated as the third map information and added to the second map information (S908).

Next, the processor clusters the data of the second map information based on shape information and interpolates a missing section of the object recognition information based on associations between the clusters. The processor clusters lane line data of the second map information based on shape similarity (e.g., straight segments, curved segments, or parallel boundaries, etc.). The processor analyzes the associations between the clusters and generates a virtual line based on the associations (S909) (e.g., connecting fragmented lane segments, interpolating occluded areas, or filling gaps caused by sensor blind spots, etc.).

Next, the processor generates a traveling route based on the second map information and controls the behavior of the vehicle (S910). For example, the processor sets a path along the center of the detected lane and adjusts speed, steering angle, or acceleration according to lane geometry (e.g., straight path at 60 km/h, curved path at 40 km/h, or lane merge with adaptive steering, etc.).

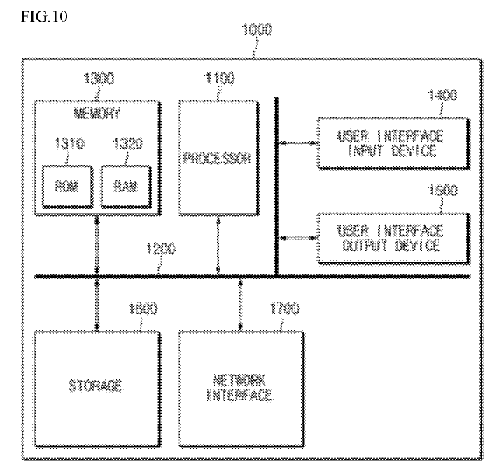

FIG. 10 shows an example computing system (e.g., a computing device of a vehicle or any other apparatus). One or more controllers, processors, etc. described herein, such as one or more components of the vehicle 100, and any other components and devices disclosed herein, may be implemented by or in the computing system as shown in FIG. 10.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

### Example

According to an example, there is provided an autonomous vehicle control device including one or more sensors, one or more processors connected to the one or more sensors, and a memory configured to store one or more programs executed by the one or more processor, wherein the sensors detect an object outside a vehicle to generate object recognition information and collect traveling data of the vehicle to generate vehicle traveling information, and the processor generates first map information on an area in which the vehicle is traveling based on the object recognition information and the vehicle traveling information, determines a movement amount of the vehicle based on the vehicle traveling information, compares new object recognition information being collected with existing object recognition information and determines validity, updates the first map information based on the new object recognition information of which the validity has been verified and the movement amount of the vehicle to generate second map information, and generates a traveling route based on the second map information to control a behavior of the vehicle.

The processor may compare the new object recognition information with a reference value determined based on the existing object recognition information and determine the validity.

The processor may set the reference value using a statistical value of the object recognition information of which the validity has been verified at a previous time point.

The processor may generate correction data based on the new object recognition information of which the validity has been verified and the movement amount of the vehicle and update the first map information based on the correction data to generate the second map information.

The processor may determine an overlap section in which the new object recognition information overlaps the first map information reflecting the movement amount of the vehicle.

The processor may generate correction data based on an error between the new object recognition information and the first map information in the overlap section.

The processor may generate third map information on an area in which the vehicle is traveling based on the new object recognition information that is not included in the overlap section and merge the third map information with the second map information.

The processor may cluster data of the second map information based on shape information and interpolate a missing section of the object recognition information in the second map information based on an association between clusters.

The processor may determine a reliability value of the first map information or the second map information based on quality, color, and attribute information of the object recognition information and generate the first map information or the second map information using object recognition information having the reliability value greater than or equal to a preset threshold value.

The processor may determine operating states of the sensors based on the object recognition information and the traveling data of the vehicle and determine whether to generate the first map information or the second map information according to the operating states of the sensors.

According to an example, there is provided a method of controlling an autonomous vehicle, which is performed by a computing device having one or more sensors, one or more processors, and a memory for storing one or more programs executed by the one or more processors, which includes detecting, by the sensors, an object outside a vehicle to generate object recognition information and collecting traveling data of the vehicle to generate vehicle traveling information, generating, by the processor, first map information on an area in which the vehicle is traveling based on the object recognition information and the vehicle traveling information, determining, by the processor, a movement amount of the vehicle based on the vehicle traveling information, comparing new object recognition information being collected with existing object recognition information and determining validity, updating, by the processor, the first map information based on the new object recognition information of which the validity has been verified and the movement amount of the vehicle to generate second map information, and generating, by the processor, a traveling route based on the second map information to control a behavior of the vehicle.

The determining of the validity may include comparing the new object recognition information with a reference value determined based on the existing object recognition information and determining the validity.

The determining of the validity may include setting the reference value using a statistical value of the object recognition information of which the validity has been verified at a previous time point.

The generating of the second map information may include generating correction data based on the new object recognition information of which the validity has been verified and the movement amount of the vehicle and generating the second map information by updating the first map information based on the correction data.

The generating of the second map information may include determining an overlap section in which the new object recognition information overlaps the first map information reflecting the movement amount of the vehicle.

The generating of the second map information may include generating correction data based on an error between the new object recognition information and the first map information in the overlap section.

The generating of the second map information may include generating third map information on an area in which the vehicle is traveling based on the new object recognition information that is not included in the overlap section and merging the third map information with the second map information.

The generating of the second map information may include clustering data of the second map information based on shape information and interpolating a missing section of the object recognition information in the second map information based on an association between clusters.

The method may further include determining, by the processor, a reliability value of the first map information or the second map information based on quality, color, and attribute information of the object recognition information, wherein the first map information and the second map information may be generated based on object recognition information having the reliability value greater than or equal to a preset threshold value.

The method may further include determining, by the processor, operating states of the sensors based on the object recognition information and the traveling data of the vehicle, and determining, by the processor, whether to generate the first map information or the second map information based on the operating states of the sensors.

An autonomous vehicle control device and method according to examples can provide a technology for generating a local map in real time using a sensor previously applied to a vehicle, selecting highly reliable data, correcting errors, and interpolating missing sections.

Accordingly, an autonomous vehicle can respond to a traveling environment that varies in real time and travel stably.

Although the present disclosure has been described above with reference to examples, those skilled in the art will understand that the present disclosure may be modified and changed variously without departing from the spirit and scope of the present disclosure as described in the appended claims.

What is claimed is:

1. An apparatus of a vehicle, the apparatus comprising:
one or more sensors configured to obtain:
object recognition information about an object outside the vehicle, and
vehicle traveling information about traveling data of the vehicle;
one or more processors coupled to the one or more sensors; and
a memory storing one or more programs that, when executed by the one or more processors, are configured to cause the apparatus to:
generate, based on the object recognition information and the vehicle traveling information, first map information on an area in which the vehicle is traveling,
determine, based on the vehicle traveling information, a movement amount of the vehicle,
obtain and validate new object recognition information by comparing the new object recognition information with previously obtained object recognition information,
generate second map information by updating the first map information based on the new validated object recognition information and the movement amount of the vehicle,
output, based on the second map information, a signal indicating a traveling route, and
control, based on the signal, driving of the vehicle.

2. The apparatus of claim 1, wherein the one or more programs, when executed by the one or more processors, are configured to cause the apparatus to compare the new object recognition information with a reference value determined based on the previously obtained object recognition information and determine validity of the new object recognition information.

3. The apparatus of claim 2, wherein the one or more programs, when executed by the one or more processors, are configured to cause the apparatus to set the reference value using a statistical value of the object recognition information, and wherein the object recognition information has been validated at a previous time point.

4. The apparatus of claim 1, wherein the one or more programs, when executed by the one or more processors, are configured to cause the apparatus to:
generate correction data based on the new validated object recognition information and the movement amount of the vehicle, and
generate the second map information by updating the first map information based on the correction data.

5. The apparatus of claim 1, wherein the one or more programs, when executed by the one or more processors, are configured to cause the apparatus to determine an overlap section in which the new object recognition information overlaps the first map information, and wherein the first map information has been adjusted based on the movement amount of the vehicle.

6. The apparatus of claim 5, wherein the one or more programs, when executed by the one or more processors, are configured to cause the apparatus to generate correction data based on a positional difference between the new object recognition information and the first map information within the overlap section.

7. The apparatus of claim 5, wherein the one or more programs, when executed by the one or more processors, are configured to cause the apparatus to:
generate third map information on an area in which the vehicle is traveling based on a portion of the new object recognition information that is outside the overlap section, and
merge the third map information with the second map information.

8. The apparatus of claim 1, wherein the one or more programs, when executed by the one or more processors, are configured to cause the apparatus to:
cluster data included in the second map information based on shape information associated with the data, and
interpolate a missing section of the second map information based on an association between the clustered data.

9. The apparatus of claim 1, wherein the one or more programs, when executed by the one or more processors, are configured to cause the apparatus to:
determine a reliability value of the first map information or the second map information based on quality, color, and attribute information of the object recognition information; and
generate the first map information or the second map information using object recognition information based on the reliability value being greater than or equal to a preset threshold value.

10. The apparatus of claim 1, wherein the one or more programs, when executed by the one or more processors, are configured to cause the apparatus to:
determine operating states of the one or more sensors based on the object recognition information and the traveling data of the vehicle, and
determine, based on the operating states of the one or more sensors, whether to generate the first map information or the second map information.

11. A method performed by an apparatus of a vehicle, the method comprising:
detecting, by one or more sensors, an object outside the vehicle to obtain object recognition information and collecting traveling data of the vehicle to obtain vehicle traveling information;
generating, based on the object recognition information and the vehicle traveling information, first map information on an area in which the vehicle is traveling;
determining, based on the vehicle traveling information, a movement amount of the vehicle;
obtaining and validating new object recognition information by comparing the new object recognition information with previously obtained object recognition information;
generating second map information by updating the first map information based on the new validated object recognition information and the movement amount of the vehicle;
outputting, based on the second map information, a signal indicating a traveling route; and
controlling, based on the signal, driving of the vehicle.

12. The method of claim 11, wherein the validating of the new object recognition information comprises:
comparing the new object recognition information with a reference value determined based on the previously obtained object recognition information; and
validating, based on the comparing, the new object recognition information .

13. The method of claim 12, wherein the validating of the new object recognition information comprises setting the reference value using a statistical value of the object recognition information, and wherein the object recognition information has been validated at a previous time point.

14. The method of claim 11, wherein the generating of the second map information comprises:
generating correction data based on the new validated object recognition information and the movement amount of the vehicle; and
generating the second map information by updating the first map information based on the correction data.

15. The method of claim 11, wherein the generating of the second map information comprises determining an overlap section in which the new object recognition information overlaps the first map information, and wherein the first map information has been adjusted based on the movement amount of the vehicle.

16. The method of claim 15, wherein the generating of the second map information comprises generating correction data based on a positional difference between the new object recognition information and the first map information within the overlap section.

17. A vehicle comprising:
a sensor configured to obtain object recognition information and vehicle traveling information, wherein object recognition information is associated with an object outside the vehicle, and wherein the vehicle traveling information is associated with traveling data of the vehicle;
a driving control circuit configured to control autonomous driving of the vehicle; and
a processor circuit configured to:
generate, based on the object recognition information and the vehicle traveling information, map information on an area where the vehicle is traveling,
determine, based on the vehicle traveling information, a movement amount of the vehicle,
validate the object recognition information based on object recognition information validated at a previous time point,
based on the validated object recognition information and the movement amount of the vehicle, update the map information,
output a signal indicating a traveling route based on the updated map information, and
control, via the driving control circuit and based on the signal, driving of the vehicle.

18. The vehicle of claim 17, wherein the processor circuit is configured to update the map information by generating correction data based on a positional difference between the object recognition information and the object recognition information validated at the previous time point, and wherein the correction data is determined using a first weighting factor assigned to the object recognition information and a second weighting factor assigned to the object recognition information validated at the previous time point, the second weighting factor being greater than the first weighting factor.

19. The vehicle of claim 17, wherein the processor circuit is configured to interpolate a missing section of the map information by generating a virtual line, wherein the virtual line is determined based on associations between clusters of lane line data or road boundary data derived from the object recognition information.

20. The vehicle of claim 17, wherein the processor circuit is configured to:
assign a reliability value to the object recognition information based on at least one of quality information, color information, or attribute information associated with the object, and
generate the map information using the object recognition information based on the reliability value being greater than or equal to a preset threshold.
